(19) United States
(12) Patent Application Publication
(10) Pub. No.: US 2005/0018859 A1
(43) Pub. Date: Jan. 27, 2005

(54) Optically driven audio system

(76) Inventor: Jeffrey C. Buchholz, Cross Plains, WI (US)

Correspondence Address: DEWITT ROSS & STEVENS S.C.;Intellectual Property Department, US Bank Building, 8000 Excelsior Drive, Suite 401, Madison, WI, 53717-1914, US

(21) Appl. No.: 10/395,480

(22) Filed: Mar. 24, 2003

Related U.S. Application Data
(60) Provisional application No. 60/368,467, filed on Mar. 27, 2002.

(51) Int. Cl. H04R 1/10; H04R 25/00

(52) U.S. Cl. 381/74; 381/370

(57) ABSTRACT

An audio system includes an earplug with a speaker to deliver sound to the ear, and/or a microphone which captures sound in the ear canal, and an earmuff is worn over the earplug. The earplug receives sound signals from the earmuff (and/or transmits captured sound signals to the earmuff) by translating such sound signals into light signals which are transmitted over a free space situated between the earmuff and earplug. The light signals are then received at the earplug and/or earmuff and converted to electrical signals which may be further transmitted (e.g., from the earmuff to some external communications device) or converted to sound (e.g., in the earplug by having the electrical signals drive an earplug speaker). If power is required by the earplug, the need for on-board power sources may be avoided by converting light transmitted from the earmuff into power at the earplug. Electrical shock and physical snag hazards are avoided, and the earmuff is easily put on and removed, owing to the lack of wires or other physical connections between the earplug and earmuff. Additionally, by avoiding wires or radio transmission between the earplug and earmuff, electromagnetic interference may be reduced.

### CROSS-REFERENCE TO RELATED APPLICATIONS

This application claims priority under 35 USC §119(e) to U.S. Provisional Patent Application 60/368,467 filed 27 Mar. 2002, the entirety of which is incorporated by reference herein.

### STATEMENT REGARDING FEDERALLY SPONSORED RESEARCH

This invention was made with United States government support awarded by the United States Navy (Naval Air Warfare Center Aircraft Division), Contract No. N68335-02-C-3040. The United States has certain rights in this invention.

### FIELD OF THE INVENTION

This disclosure concerns an invention relating generally to personal audio equipment, and more specifically to headsets, earplugs, and similar personal audio listening equipment.

### BACKGROUND OF THE INVENTION

In high noise environments, in-the-ear active earplugs—wherein speakers deliver sound directly to the ear canal—help improve signal to noise, and thus the intelligibility of transmitted music or speech. The earplug serves as a passive attenuator of ambient noise to provide the ear with protection from dangerous sound levels, and reduces the ambient noise's interference with sound generated by the earplug speaker. Active earplugs usually only include sound output devices, such as electroacoustic speakers (i.e., speakers which generate sound output from electrical input). However, active earplugs may also include sound input devices in the earplug—such as acoustoelectric microphones, which generate electrical output from input sounds—to generate output signals representing the level of ambient noise “leaked” into the ear canal, and/or signals representing the wearer's speech sounds (which can be picked up in the ear canal). The ambient noise signals can then be used to provide active noise cancellation in the ear canal, or detected speech sounds can be used to allow two-way communication (i.e., the wearer of the earplugs can both hear transmitted sounds and can transmit his/her own speech). See, for example, U.S. Pat. Nos. 4,985,925 and 5,692,059.

However, the prior systems tend to suffer from certain disadvantages. Where they receive and/or send sound signals via wire, they can be subject to electromagnetic interference, and they tend to “tether” the wearer to a fixed location. Where wireless technologies are used, they are also subject to interference, and additionally they tend to be heavy and bulky owing to the presence of the transmitter and/or receiver for sound signals, and owing to the need for onboard battery power.

### SUMMARY OF THE INVENTION

The invention involves audio systems which are intended to at least partially solve the aforementioned problems. To give the reader a basic understanding of some of the advantageous features of the invention, following is a brief summary of preferred versions of the earplugs. As this is merely a summary, it should be understood that more details regarding the preferred versions may be found in the Detailed Description set forth elsewhere in this document. The claims set forth at the end of this document then define the various versions of the invention in which exclusive rights are secured.

The audio system of the present invention includes an earplug which may include sound delivery and/or sound capture features as discussed above, and an earmuff is worn over the earplug to provide added noise protection in a high noise environment. The need for wire connections between the earmuff and earplug, and for onboard power sources in the earplug (i.e., batteries), may be avoided by providing both sound signals and power between the earplug and earmuff over a free space optical link: sound-encoded light signals may be delivered by light sources situated on the earplug and/or earmuff, and may be received by the other component by appropriate photoreceivers and then converted back into sound, if desired. Additionally, power may effectively be delivered over the free space by having a light source on the earmuff and/or earplug illuminate a powering photoreceiver on the other component, thereby powering that other component. The lack of wires between the earplug and earmuff removes electrical shock and physical snag hazards; reduces transmission of ambient noise from the earmuff to the earplug through vibration or other acoustic leakage; and allows easy don-and-doff since the earplug is not physically constrained to the earmuff. The problems with earplugs that communicate with remote wireless transceivers, such as the need for power sources onboard such earplugs and the problem of electromagnetic interference, are also avoided.

Further advantages, features, and objects of the invention will be apparent from the following detailed description of the invention in conjunction with the associated drawings.

### BRIEF DESCRIPTION OF THE DRAWINGS

FIG. 1 is a simplified cross-sectional view of an exemplary audio system including an earplug 100 which is worn by a user with an earmuff 200 placed over the earplug 100, with sound-encoded light signals being transmitted across a free space therebetween to allow the earmuff 200 to transmit sounds to, and/or receive sounds from, the earplug 100.

FIG. 2 is a schematic diagram of the exemplary audio system of FIG. 1.

### DETAILED DESCRIPTION OF PREFERRED VERSIONS OF THE INVENTION

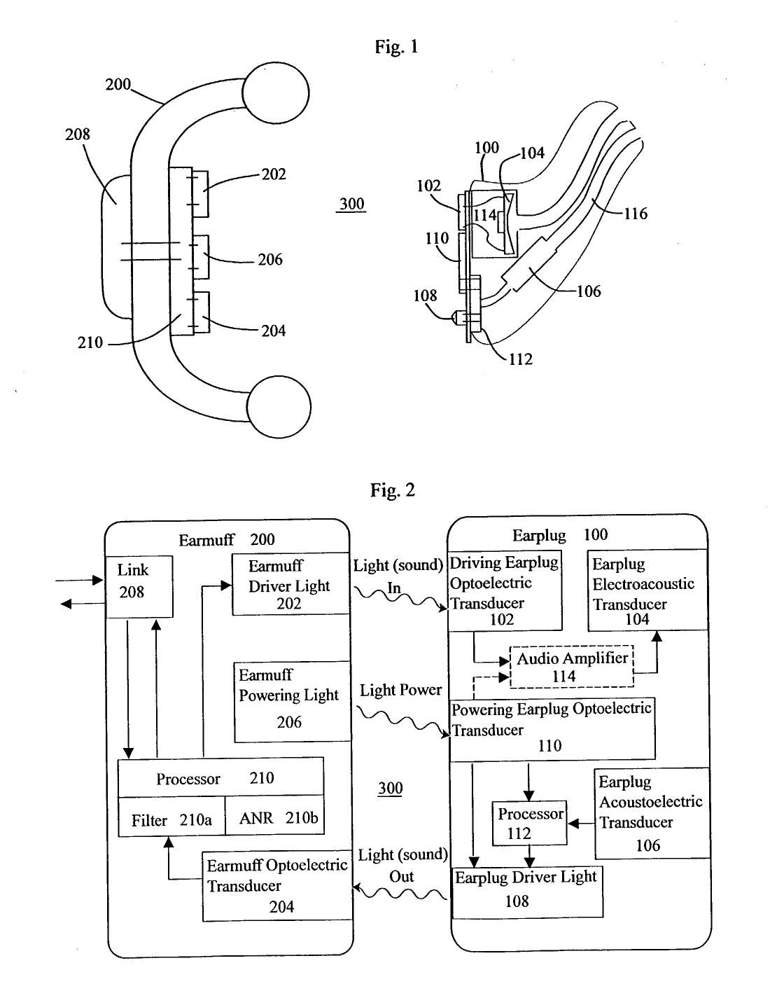

An exemplary version of the invention is illustrated in FIGS. 1 and 2, wherein an audio system includes an earplug 100 and an earmuff 200, wherein the earplug 100 receives sound signals from (and/or sends sound signals to) the earmuff 200 across a free space 300. The earplug 100 may be adapted for mounting within an ear (as depicted in FIG. 1) or on an ear (as by including an over-the-ear hook), and the earmuff preferably has an earmuff interior sized to fit over the ear which bears the earplug 100. The lack of any physical connection between the earmuff 200 and earplug 100 across the free space 300 allows the earmuff 200 to provide passive noise reduction—it reduces the ambient noise received by the ear canal (such reduction also being assisted by the earplug 100)—while preventing direct conduction of ambient sound vibration between the earmuff 200 and earplug 100. The presence of the free space 300 also allows easy “don-and-doff,” whereby a user may wear the earplug 100 while readily taking the earmuff 200 on and off at any time. Such a capability is particularly useful for military applications, wherein a user may need to (for example) be able to rapidly don and remove a helmet wherein the earmuff 200 is provided.

To briefly preview the components and functionality of the preferred audio system of FIGS. 1 and 2 (with a more detailed description being provided later in this document), the earplug 100 preferably includes an earplug sound input means 102/104 for inputting sound transmitted from the earmuff 200 to the ear, and/or an earplug sound output means 106/108 for outputting a sound measurement taken within the ear to the earmuff 200. It can additionally be useful to include an earplug powering means 110 for powering the earplug sound input means and/or earplug sound output means (if such power is necessary). The earmuff 200 then preferably includes an earmuff sound output means 202 which outputs sound signals to the earplug sound input means 102/104, and/or an earmuff sound input means 204 which receives sound signals from the earplug sound output means 106/108. An earmuff powering means 206 for remotely powering the earplug powering means 110 can also be useful. Each of these components and their functionality will now be discussed at greater length.

Looking initially to the interrelationship between the earmuff sound output means 202 and the earplug sound input means 102/104, the earmuff sound output means includes an earmuff driver light 202 which transmits sound-encoded light signals to the driving earplug optoelectric transducer 102, which provides electrical output upon receipt of the light input. When it is stated that the earmuff driver light 202 transmits “sound-encoded” light signals, this means that the light signal is an optical signal bearing sound information —for example, a light signal carrying sound information via encoding schemes such as amplitude modulation, pulse width modulation (PWM), or pulse frequency modulation (PFM). The earmuff driver light 202 may take the form of (for example) a light emitting diode, a laser diode, a fiberoptic terminal (which emits light emitted by a separate light source), or any other appropriate light source. The driving earplug optoelectric transducer 102 may take the form of any appropriate photoreceiver, such as a Si, GaAs, or Ge photocell having an optimal power generation range coinciding with the wavelength(s) at which the earmuff driver light 202 emits light. The driving earplug optoelectric transducer 102 converts the received sound-encoded light signal into a sound-encoded electrical signal. This sound-encoded electrical signal is then provided to the earplug electroacoustic transducer 104 (e.g., a common electrically-driven diaphragm, piezoelectric, or other suitable speaker) to provide acoustic output into the ear canal upon receipt of the electrical input. Thus, the sound signal travels as light from the earmuff driver light 202 to the driving earplug optoelectric transducer 102 across the free space 300, then as an electrical signal to the earplug electroacoustic transducer 104, at which point it is converted back into sound and delivered to the ear canal.

As depicted by the exemplary embodiment of FIGS. 1 and 2, the sound signal optically transmitted by the earmuff driver light 202 may initially be received by the earmuff 200 as a sound-encoded electrical signal at link 208, which may be a radio receiver or a wire input. The link 208 then provides the sound-encoded electrical signal to a processor 210—a circuit board or chip containing appropriate circuitry—which may translate the electrical signal into a desired format (e.g., PWM, PFM) to drive the earmuff driver light 202 to generate analogous sound-encoded optical signals. However, the link 208 may initially receive sound-encoded optical signals rather than sound-encoded electrical signals. For example, the link 208 may receive sound information via a light signal transmitted over a fiberoptic cable input, as opposed to a wire or radio communication. In this case, the processor 210 might simply pass the sound-encoded optical signals to the earmuff driver light 202 without alteration. Thus, the link 208 may simply be a fiberoptic input terminal which passes sound-encoded optical signals directly to the earmuff driver light 202, which in this case might merely be a terminal end of a fiberoptic cable transmitting the sound-encoded optical signals from the link 208. Alternatively, the processor 210 could translate a sound-encoded optical signal coming in from the link 208 to another encoding scheme prior to passing the signal to the earmuff driver light 202; for example, if the link 208 receives a sound-encoded optical signal in PFM format, the processor 210 might convert it to PWM format prior to passing it to the earmuff driver light 202.

Where the foregoing arrangement is used, the audio system allows the earmuff 200 to communicate sound information to the earplug 100 via a light signal traveling through the free space 300, with the earplug 100 then converting the light signal back into sound for delivery to the wearer's ear. In some cases, it may additionally or alternatively be desirable to use the earplug sound output means 106/108 to transmit sound signals from the earplug 100 to the earmuff sound input means 204 in the earmuff 200. As one example, it might be useful to capture the ambient sound level within the ear canal and use it to provide feedback of active noise reduction signals, i.e., to combine any sound signals from the link 208 with the inverse of the measured ear canal ambient noise, thereby effectively cancelling out the ambient noise within the ear canal and making the ambient noise effectively inaudible. As another example, it may be useful to collect voice signals from the wearer of the earplug 100 by picking up such voice signals within the ear canal and transmitting them back to the earmuff 200 and link 208. When such arrangements are provided, the earplug sound output means 106/108 may include an earplug acoustoelectric transducer 106, which may take the form of an electret or other suitable microphone which obtains acoustic input from within the ear canal and generates a sound-encoded electrical output signal. The sound-encoded electrical signal is then passed to an earplug driver light 108, which may take the form of an LED, laser diode, or other appropriate light source whereby the sound-encoded electrical signal is converted to a sound-encoded light signal transmitted to the earmuff 200. If desired, a processor 112 may be included between the earplug acoustoelectric transducer 106 and earplug driver light 108 to provide amplification and/or format translation (e.g., translation of the sound-encoded electrical signal from the earplug acoustoelectric transducer 106 into PWM, PFM, or other formats). If amplification is provided, it might be powered by batteries within the earplug 100, or by other earplug powering means 110 to be discussed later in this document.

The earplug driver light 108 transmits the sound-encoded light signal across the free space 300 to the earmuff optoelectric transducer 204, which converts the sound-encoded light signal back into a sound-encoded electrical signal. The earmuff optoelectric transducer 204, like the driving earplug optoelectric transducer 102, may take the form of any appropriate photovoltaic element or other optoelectric transducer. However, if all of the earmuff driver light 202, the earplug driver light 108, the driving earplug optoelectric transducer 102, and the earmuff optoelectric transducer 204 are present, the earplug driver light 108 and earmuff optoelectric transducer 204 are preferably chosen to operate over a different wavelength range than the earmuff driver light 202 and the driving earplug optoelectric transducer 102, so as to avoid crosstalk. The sound-encoded electrical signal generated by the earmuff optoelectric transducer 204 may then be passed to the link 208 for transmission from the earmuff 200.

However, the sound-encoded electrical signal generated by the earmuff optoelectric transducer 204 may first undergo processing within a processor 210 before being passed to the link 208. The processor 210 could perform a variety of functions; for example, it might include a voice filter 210a which specifically attenuates all components of the sound-encoded electrical signal save for a voice signal. This could be done by passive filtration of frequencies outside those corresponding to human speech, or by active filtration (active noise reduction), e.g., by subtracting out any signals corresponding to ambient noise measured outside the earmuff 200 (since such ambient noise might also be present in attenuated form within the ear canal). The filtered voice signal could then be passed to the link 208 for delivery from the earmuff 200. Alternatively or additionally, the processor might include an active noise reduction processor 210b which takes the components of the sound-encoded electrical signal and inverts them to generate cancellation signals. The cancellation signals can then be passed to the earmuff driver light 202 (in conjunction with any signals passed from the link 208) for transmission to the driving earplug optoelectric transducer 102 and earplug electroacoustic transducer 104, thereby canceling out the ambient noise in the ear canal and presenting the wearer of the earplug 100 with a safer sound level (one less likely to cause hearing damage), as well as effectively clearer sound transmissions from the link 208.

If it is necessary or useful for the earplug 100 to have power—for example, if the processor 112 requires power for amplification of signals transmitted from the earplug acoustoelectric transducer 106, or if the earplug driver light 108 requires a supplementary power source in order to generate a sound-encoded signal of sufficient magnitude—the earmuff powering means 206 and earplug powering means 110 may be provided. The earmuff powering means might be provided by situating an earmuff powering light 206 (e.g., an LED, laser diode, or other suitable light source) on the interior of the earmuff 200. The earmuff powering means 206 may transmit light across the free space 300. Such light may be received by earplug powering means provided as a powering earplug optoelectric transducer 110 (i.e., a photocell or other suitable optoelectric transducer), which provides electrical output upon receiving light. Thus, the earmuff powering light 206 will stimulate the powering earplug optoelectric transducer 110 to generate power, which may in turn power the earplug driver light 108 or other components of the earplug 100.

The foregoing arrangement has been constructed and successfully tested with use of the following components and modes of operation, though other choices are possible. Regarding the earmuff sound output means 202 and the earplug sound input means 102/104, the earmuff driver light 202 is an LED which transmits an amplitude modulated infrared light signal to the driving earplug optoelectric transducer 102. The driving earplug optoelectric transducer 102 is a Si solar cell/photovoltaic element having peak conversion efficiency at 850-900 nm (infrared) wavelength and an area of approximately 100 square mm, and having a low internal impedance which is closely matched with the earplug electroacoustic transducer 104, a 13 mmm-diameter speaker with impedance of 32 ohms. The driving earplug optoelectric transducer 102 and earplug electroacoustic transducer 104 are connected via 30 gauge wires.

As for the earmuff powering means 206 and the earplug powering means 110, the earmuff powering light 206 is a constantly on 660 nm wavelength (red) LED which transmits light to the powering earplug optoelectric transducer 110, a 2-junction GaAs-based solar cell photoreceiver having approximately 180 square mm area. Note that to avoid crosstalk, different wavelength ranges are used for transmitted information and for power generation in the foregoing components—in other words, the earmuff driver light 202 and driving earplug optoelectric transducer 102 operate on different wavelengths or wavelength ranges than the earmuff powering light 206 and the powering earplug optoelectric transducer 110, thereby preventing the earmuff powering light 206 from driving the driving earplug optoelectric transducer 102, and preventing the earmuff driver light 202 from driving the powering earplug optoelectric transducer 110.

The processor 112, which assists in powering the earplug sound output means 106/108 (and thus the earmuff sound input means 204), includes a single transistor preamplifier connected to a low voltage class-d audio amplifier to amplify the sound-encoded electrical signal generated by the earplug acoustoelectric transducer 106. The resulting output then directly drives the earplug driver light 108 (an LED) with a PWM drive current, resulting in a PWM sound-encoded light signal. The earmuff optoelectric transducer 204, a Si photocell, then receives the sound-encoded light signal from the earplug driver light 108. The earplug acoustoelectric transducer 106 is an electret microphone having 4.5 mm diameter, and is connected to the processor 112 by 30 gauge wire.

In an alternative arrangement, the driving earplug optoelectric transducer 102 is a Si photodiode operating in photoconductive mode (though photovoltaic mode is also possible), and it therefore does not provide significant voltage response. The earplug electroacoustic transducer 104 is not driven directly from the earplug optoelectric transducer 102 in this scheme, but is rather controlled by a class-d amplifier circuit (shown in phantom at 114 in FIG. 2), which is powered by the earplug optoelectric transducer 110 and which receives its input signal from the earplug optoelectric transducer 102. The earplug acoustoelectric transducer 106 may again use a class-d amplifier within the processor 112 to drive the earplug driver light 108, as in versions of the invention described previously. Alternatively or additionally, the earplug optoelectric transducer 110 may use a boost-type DC—DC converter within the processor 112 to drive the LED of the earplug driver light 108 in PWM or PFM modes in accordance with the output of the earplug acoustoelectric transducer 106. The driving earplug optoelectric transducer 102 could alternatively be a different Si, Ge, GaAs, or other photovoltaic element which has sufficient response speed and wavelength sensitivity that its output accurately reflects light input from the earmuff driver light 202.

It is also possible to skip PWM and/or PFM encoding (and/or amplification) in the foregoing arrangements; for example, to omit the processor 112 and simply have the earplug driver light 108 driven in analog fashion by direct use of the sound-encoded electrical signal generated by the earplug acoustoelectric transducer 106. However, while direct analog broadcasting is possible, it has the disadvantage of overall signal level sensitivity as opposed to PWM and PFM broadcasting with signal amplification.

Another possible variation involves omitting the earmuff powering light 206 and using the earmuff driver light 202 to both drive the driving earplug optoelectric transducer 104 and also power the powering earplug optoelectric transducer 110, in which case the driving earplug optoelectric transducer 104 and the powering earplug optoelectric transducer 110 might even be combined into a single transducer. Here the sound-encoded light signal and the powering light signal transmitted by the earmuff driver light 202 are sent as a combined signal, for example, as a PWM or PFM signal wherein the PWM encoding would carry the encoded sound and the carrier frequency may be used to extract the power. In this case, the amplifier 114 is usefully included as a class-a or class-d amplification device.

Regarding choice of optoelectric transducers and lights, the wavelength(s) of each light source is preferably coupled as closely as possible to the efficient conversion wavelengths of the optoelectric transducer with which it will communicate, and as noted above, transducers and light sources which are not to communicate with each other preferably have different operating wavelength ranges to avoid crosstalk. Infrared light sources are preferred so that any light leakage outside the earmuff 200 will not be visible. However, it can be expensive to provide different infrared operating ranges if all of the earmuff driver light 202/earplug optoelectric transducer 102 pair, the earplug driver light 108/earmuff optoelectric transducer 204 pair, and the earmuff powering light 206/earplug optoelectric transducer 110 pair are present. If significant separation in operating ranges is desired to minimize crosstalk, this will generally require that at least one of the pairs operate at wavelengths above 1500 nm, a point at which appropriate photoreceivers become (at present) more expensive. Thus, as discussed above, it is acceptable to have one or more pairs operate in the visible range as well, and/or to avoid crosstalk by use of different signal encoding schemes between different pairs (e.g., by having pair 202/102 communicate via an amplitude modulated signal, whereas pair 108/204 communicates via a PWM signal, as discussed previously).

Looking more specifically to the structure of the earplug (as particularly illustrated in FIG. 1), the earplug 100 may take a variety of forms: for example, it may be fabricated as a custom-molded plug for deep insertion into the second bend of the ear canal (as depicted in FIG. 1), or it may be fabricated as a generic-fit earplug made of soft rubber or expandable foam for moderate insertion into the ear canal. In either case, for greatest comfort, it is useful to provide most circuit boards or other components at or near the surface of the earplug 100 so they do not extend into the ear canal. However, to minimize space, the earplug electroacoustic transducer 104 and earplug acoustoelectric transducer 106 may be situated within the interior of the sound-damping materials of the earplug 100, and may include sound tubes 116 (e.g., 0.125 inch outer diameter silicone tubing) as shown in FIG. 1 to communicate sound to and from the ear canal.

The earmuff 200, which is not depicted in detail in the Figures, may also take a wide variety of forms, and may be configured similarly to virtually any standard audio headset. However, a sound-damping circumaural earmuff-type headset, wherein large cups with padded rims cover the user's ears, is particularly preferred. Any circuitry, light sources, and/or photovoltaic cells may simply be situated within each ear cup, preferably nearer its base than its rim to better maintain a short and direct line of sight between the relevant components of the earplugs 100 and earmuff 200. In this respect, the various aforementioned light sources—the earmuff driver light 202, the earmuff drive light 206, and/or the earplug driver light 108—are preferably not provided as single-source light sources (i.e., as a single LED, laser diode, or other light source), and are rather provided as spaced arrays of light sources, e.g., spaced about an area on the interior of the earmuff 200 and/or the earplug 100. This arrangement helps to assure pickup of the light signals by the earplug 100 regardless of variation in the position of the earmuff 200, for example, the earplug 100 may still receive the light signals even if the earmuff 200 is rotated about the wearer's ear. An alternative or additional arrangement is to provide the driving earplug optoelectric transducer 102, powering earplug optoelectric transducer 110, and/or earmuff optoelectric transducer 204 in multiple parts spread across the areas of the earplug 100 and/or the earmuff 200.

Various preferred versions of the invention have been described above to illustrate different possible features of the invention and the varying ways in which these features may be combined. Apart from combining the different features of the foregoing versions in varying ways, other modifications are also considered to be within the scope of the invention. Thus, the invention is not intended to be limited to the preferred versions of the invention described above, but rather is intended to be limited only by the claims set out below, with the invention encompassing all different versions that fall literally or equivalently within the scope of these claims.

1. An audio system comprising:
a. an earplug adapted for mounting on or within an ear, the earplug including:
(1) an earplug optoelectric transducer providing electrical output upon receipt of light input; and
(2) an earplug electroacoustic transducer coupled to the earplug optoelectric transducer, the earplug electroacoustic transducer providing acoustic output upon receipt of electrical input;
b. an earmuff with an earmuff interior sized for fitting over an ear which bears the earplug, the earmuff interior including an earmuff driver light situated therein;
wherein the earmuff driver light may be actuated to transmit light to the earplug optoelectric transducer, in turn generating an acoustic output from the earplug electroacoustic transducer.

2. The audio system of claim 1 wherein the earmuff driver light is separated from the earplug optoelectric transducer by a free space.

3. The audio system of claim 1 wherein:
a. the earplug further includes an earplug driver light thereon, and
b. the earmuff interior includes an earmuff optoelectric transducer providing electrical output upon receipt of light input from the earplug driver light.

4. The audio system of claim 3 further comprising a noise processor receiving electrical output from the earmuff optoelectric transducer and providing electrical input to the earmuff driver light.

5. The audio system of claim 3 wherein the earplug further includes an earplug acoustoelectric transducer coupled to the earplug driver light, the earplug acoustoelectric transducer providing electrical output to the earplug driver light upon receipt of acoustic input.

6. The audio system of claim 3 wherein the earplug further includes a powering earplug optoelectric transducer providing electrical output to the earplug driver light upon receipt of light input.

7. The audio system of claim 6 wherein the earplug optoelectric transducer which receives light from the earmuff driver light is integral with the powering earplug optoelectric transducer, whereby the powering earplug optoelectric transducer both
(1) generates an acoustic output from the earplug electroacoustic transducer, and
(2) provides electrical output to the earplug driver light, upon receipt of light input.

8. The audio system of claim 6 wherein the earmuff interior includes a earmuff powering light situated therein and supplying light to the powering earplug optoelectric transducer.

9. The audio system of claim 8 wherein the earmuff driver light which transmits light to the earplug optoelectric transducer is integral with the earmuff powering light, whereby the earmuff powering light both:
(1) transmits light to the earplug optoelectric transducer to generate an acoustic output from the earplug electroacoustic transducer, and
(2) supplies light to the powering earplug optoelectric transducer to generate power therein.

10. The audio system of claim 1 wherein the earplug further includes:
a. an earplug driver light, and
b. a powering earplug optoelectric transducer providing electrical output to the earplug driver light upon receipt of light input.

11. The audio system of claim 10 wherein the earmuff interior includes a earmuff powering light situated therein and supplying light to the powering earplug optoelectric transducer to power the earplug driver light.

12. The audio system of claim 10 wherein the earplug further includes an earplug acoustoelectric transducer providing electrical output to the earplug driver light upon receipt of acoustic input.

13. The audio system of claim 10 wherein the earmuff further includes an earmuff optoelectric transducer which generates electrical output upon receipt of light input from the earplug driver light.

14. The audio system of claim 13 further comprising a noise processor receiving electrical output from the earmuff optoelectric transducer and providing electrical input to the earmuff driver light.

15. An audio system comprising:
a. an earplug adapted for mounting on or within an ear, the earplug including:
(1) an earplug acoustoelectric transducer, the earplug electroacoustic transducer providing electrical output upon receipt of acoustic input;
(2) an earplug driver light coupled to the earplug electroacoustic transducer and generating light in response to acoustic input therein;
b. an earmuff with an earmuff interior sized for fitting over the earplug, the earmuff interior including an earmuff optoelectric transducer providing electrical output upon receipt of light input from the earplug driver light,
whereby acoustic input at the earplug acoustoelectric transducer results in electrical output from the earmuff optoelectric transducer.

16. The audio system of claim 15 wherein the earplug driver light is separated from the earmuff optoelectric transducer by a free space.

17. The audio system of claim 15 wherein:
a. the earmuff interior further includes an earmuff driver light;
b. the earplug further includes:
(1) an earplug optoelectric transducer providing electrical output upon receipt of light input from the earmuff driver light; and
(2) an earplug electroacoustic transducer
(a) coupled to the earplug optoelectric transducer, and
(b) providing acoustic output upon receipt of electrical input from the earplug optoelectric transducer.

18. The audio system of claim 17 further comprising a noise processor interposed between the earmuff optoelectric transducer and the earmuff driver light.

19. The audio system of claim 15 wherein:
a. the earmuff interior further includes an earmuff powering light;
b. the earplug further includes a powering earplug optoelectric transducer, the powering earplug optoelectric transducer providing electrical output to the earplug driver light upon receipt of light input from the earmuff powering light.

20. An audio system comprising:
a. an earplug adapted for mounting on or within an ear, the earplug including:
(1) an earplug optoelectric transducer providing electrical output upon receipt of light input; and
(2) an earplug driver light coupled to the earplug optoelectric transducer;
b. an earmuff with an earmuff interior sized for fitting over an ear which bears the earplug, the earmuff interior including an earmuff powering light situated therein;
wherein the earplug optoelectric transducer powers the earplug driver light upon receipt of light from the earmuff powering light.

21. The audio system of claim 20 wherein the earmuff powering light is separated from the earplug optoelectric transducer by a free space.

22. The audio system of claim 20 wherein:
a. the earmuff interior further includes an earmuff driving light situated therein;
b. the earplug further includes:
(1) a driving earplug optoelectric transducer providing electrical output upon receipt of light input; and
(2) an earplug electroacoustic transducer coupled to the driving earplug optoelectric transducer, the earplug electroacoustic transducer providing acoustic output upon receipt of electrical input from the driving earplug optoelectric transducer.

23. The audio system of claim 22 wherein the earmuff interior further includes an earmuff optoelectric transducer situated therein, the earmuff optoelectric transducer generating an electrical output upon receipt of light from the earplug driver light.

24. The audio system of claim 23 further comprising a noise processor receiving the electrical output from the earmuff optoelectric transducer, and providing an electrical input to the earmuff driving light.

25. The audio system of claim 23 wherein the earplug further includes an earplug acoustoelectric transducer, the earplug electroacoustic transducer providing electrical output to the earplug driver light upon receipt of acoustic input.

26. The audio system of claim 20 wherein the earplug further includes an earplug acoustoelectric transducer, the earplug electroacoustic transducer providing electrical output to the earplug driver light upon receipt of acoustic input.
